(19) United States
(12) Patent Application Publication
(10) Pub. No.: US 2023/0000058 A1
(43) Pub. Date: Jan. 5, 2023

(54) System for Pet Feeding Activity Detection and Indication

(71) Applicant: Jeff Baker, Newbury Park, CA (US)

(72) Inventor: Jeff Baker, Newbury Park, CA (US)

(73) Assignee: Jeff Baker, Newbury Park, CA (US)

(21) Appl. No.: 17/856,683

(22) Filed: Jul. 1, 2022

Related U.S. Application Data
(60) Provisional application No. 63/203,006, filed on Jul. 2, 2021.
(60) Provisional application No. 63/324,136, filed on Mar. 27, 2022.
(60) Provisional application No. 63/331,139, filed on Apr. 14, 2022.

(51) Int. Cl. A01K 29/00; A01K 5/02; G08B 5/36

(52) U.S. Cl. CPC A01K 29/005; A01K 5/02; G08B 5/36

(57) ABSTRACT

Disclosed is an animal feeding activity detector integrated into or affixed to a feeding bowl, and which has activity sensing means, decision means, and indication means. The sensing means measures a physical quantity indicative of animal feeding activity. The decision means, comprising a microcontroller with programmed instructions, ascertains if measurements qualify as animal feeding activity. The indication means gives a spatially and temporally immediate indication of whether activity has been detected.

### CROSS-REFERENCE TO RELATED APPLICATIONS

This patent application claims the benefit of U.S. Prov. Ser. No. 63/203,006 filed Jul. 2, 2021; and U.S. Prov. Ser. No. 63/324,136, filed Mar. 27, 2022; and U.S. Prov. Ser. No. 63/331,139, filed Apr. 14, 2022. All three of the above applications are incorporated by reference herein.

### BACKGROUND OF THE INVENTION

A common challenge with pets is knowing whether a pet has been fed. A forgetful or absent-minded owner might, by mistake or misremembrance, feed a pet twice or not at all. Or, in a household with shared pet feeding responsibility, mealtime can be a ritual of several queries by shouting, phone, text message, etc., of “did you feed the dog?”

Manual methods by which owners or families indicate pet feedings, to remind themselves or each other, are simple but non-optimal solutions to this tedious problem. One example of a manual method is a calendar and pen, perhaps hung on a wall next to a pet food storage area. Besides calendars, other manual indicators could include rotatable magnets, stickers, or purpose-made arrays of flippable mechanical indicators. One example of a manual indicator is a board with mechanical sliders sold by DYFTD, LLC (a name derived from the question “did you feed the dog?), shown in FIG. 1, and available through many retail outlets.

These manual methods require intentional action which like the pet feeding itself can also be forgotten. They only transfer the question from “Did I/you feed the dog?” to “Did I/you mark the calendar?” or “Did I/you remember to flip the indicator?” Furthermore, some of the manual methods may require periodic renewal, such as monthly calendar creation, which requires enough effort that the regular practice of the technique may lapse. These manual methods are not foolproof.

Automatic pet feeding solutions, such as timed food dispensers, can at least temporarily solve this problem. These may dispense specific amounts of food at scheduled times without human intervention. However, these can be expensive, hard to clean, and prone to malfunction. They contain moving parts. They require either relatively large batteries or an electrical outlet. They are not simple.

Similarly, pet feeding bowls with integrated weigh scales are directed at implementing portion control for pet health. These may have displays to indicate the mass of food that a person is dispensing, for example in units of ounces or grams, thereby conveniently eliminating the step of transferring from a weigh scale to a pet bowl and providing the possibility of electronic tracking of food quantity through an associated cloud service and web or mobile app interface. However, being directed fully toward the goal of portion control, these pet feeding bowls do not possess the decision means for addressing the binary question of a whether a pet has been recently fed, nor the indication means for instant at-a-glance indication. Although some overweight pets will certainly benefit from portion quantification and tracking, the additional steps required (e.g., having an account; having a mobile device on hand at the moment of need; finding and opening an app; being logged into the service; paying for the service; etc.) are even greater impediments to long term use than flipping a manual indicator.

The existing manual and automatic methods mentioned above all possess a high burden of use relative to the problem they solve. The daily question of whether the dog (for example) has been fed is an annoying but minor problem, the resolution of which may not be worth much expense or effort. To be useful daily and continuously, a solution must be extremely simple to use.

### SUMMARY OF THE INVENTION

Provided is a system of automatically indicating, without human intervention and near zero burden of use, when a pet has been fed.

In a preferred embodiment, the system for pet feeding activity detection comprises a disk-like housing affixable to a pet bowl using a magnet, adhesive, or hook-and-loop fastener, wherein the housing contains electronics that provide sensing means, decision means, and at-a-glance indication means.

The electronics are built on a printed circuit board housed within the housing and in the preferred embodiment contain a coin cell battery, a microcontroller, an accelerometer, and an indication LED with an associated LED driver circuit.

The coin cell battery is for example a CR2032 3V Lithium battery available from many vendors. With judicious design for low power consumption, one such coin cell can power the pet feeding activity detector for over five years.

The microcontroller is for example an 8-bit microcontroller from the PIC16LF family of microcontrollers from Microchip, Inc., which when put into a low-power sleep mode consume only 50 nanoamperes of current. Programming the microcontroller to spend most of its time in a sleep mode provides extremely long battery life. The microcontroller is further programmed to periodically awaken and obtain measurements from the sensing means, to make decisions about whether feeding activity is detected, and to manage indication via the LED; as such it forms the decision means of the pet feeding activity detector. A useful programming paradigm for the microcontroller instructions is a state machine, at least one of which will be described in detail below; however alternate programming methods could achieve the same result.

The sensing means is an accelerometer, such as the LIS2DW12 from ST Microelectronics, Inc., which can be configured to measure motion at low frequencies (for example approximately 1 Hz) while consuming less that 1 microamp of current. The small vibrations caused by a pet nudging the bowl are sensed by the accelerometer and read by the microcontroller as data input to the decision means. Although alternate choices of technology for the sensing means will be described in alternate embodiments below, the choice of an accelerometer as the sensing means can enable further features. These include shelf mode, ship mode, and a reset action, all discussed below.

The indication means is an LED indicator. The LED is mounted on the PCB, and light from the LED is guided to the surface of the housing via a light pipe. The LED is a high efficiency ultra-bright LED, for example part number 150060GS84000 from Würth Elektronik, Inc., which requires a voltage higher than the available battery voltage. The necessary voltage is provided by a charge pump of a design well-known in the art, controlled by a pin from the microcontroller. Choosing a high efficiency LED, even with the inefficiency added by a voltage boosting circuit, allows brighter indication for less power consumption. Even with 1 mA of current, the specific LED model mentioned above provides luminous intensity of about 100 mcd; this is more than most LEDs even with 20 mA of current and is easily bright enough to be visible across a large room in daylight.

To indicate that pet feeding activity has been found, the microcontroller controls the LED driving circuit to effect flashing of the LED. The frequency and duration of the flashes are chosen to minimize power consumption. With a high efficiency and ultrabright LED such as the part mentioned above, an approximately 5 ms on-time provides high visibility. Flashing at approximately 0.5 Hz minimizes power consumption without requiring lengthy observation by a human to ascertain status.

The overall duration of indication is chosen to be sufficiently long to cover the full length of an expected feeding time window, without being so long as to unnecessarily consume power. For example, for a pet typically fed between 7 AM and 9 AM, and a feeding bowl always observed by at least 10 AM, three hours of overall indication time is sufficient. In practice, a four- to six-hour indication time is found to be optimal.

Two important aspects of the indication means are that it is immediate, and that it is binary. Immediate availability means that when within line of sight of bowl equipped with the pet feeding activity detector, a momentary glance is sufficient to ascertain whether pet feeding activity is being indicated. This immediacy is both spatial and temporal. It is spatial, because the indication is visible within spatial proximity of a pet bowl equipped with the pet feeding activity detector, where a pet parent is both reminded to wonder if a pet has been fed and physically present to do something about it. That is, the indication is immediate in the sense of being at hand precisely where needed. And the indication is also immediate in the usual temporal sense because no intermediate steps, such as for example finding a phone and opening an app, are required. That is, the indication is available at the moment it is needed.

That the indication is binary means that indication means has only two states: the LED is either flashing or not. No interpretation of numbers, or reading of a chart, or interpretation of any sort, is required. Immediacy and binariness make the pet feeding activity detector simple to use.

The choice of an accelerometer for the sensing means, as opposed to other possibilities described below, enables shelf mode, ship mode, and a reset action.

In shelf mode the pet feeding activity detector enters a low power mode in which indication is disabled. The microcontroller is programmed to recognize orientations of the accelerometer, such that the pet feeding activity detector can measure whether it is oriented within an allowed range of normal operating orientations. For example, the normal operating orientation range could be defined as having the front face of the housing within 30 degrees of vertical, and the housing rotatably oriented with an orientation mark within 60 degrees of upward. The orientation mark could be a feature of the housing design, such as having the indication LED on the front face off-center, and such that rotating the LED to an upward position puts the pet feeding activity detector into normal operation orientation. When the pet feeding activity detector determines that it is not oriented in the normal operating orientation range, it enters a low power mode.

The pet feeding activity detector may be packaged in retail packaging in an orientation outside of the normal operating orientation range so that it enters and remains in low power mode on store or warehouse shelves. And further, the retail packaging may be boxed into bulk packaging that maintains the non-operating orientation during shipping or warehouse storage. The packaging may have a feature that prevents orientation from shifting to due vibration, such as for example a low-tack adhesive or a boss that captures a feature on the housing.

Ship mode is also a mode in which the pet feeding activity detector enters low-power mode. The microcontroller is programmed to detect when the pet feeding activity detector is undergoing vibration or motion beyond what is expected from normal pet feeding activity, and to enter low power mode. Such excessive motion occurs during shipping, carrying, or transporting.

It may occasionally be desired by a human user to stop the indication of the pet feeding activity detector. A reset action enabled by the accelerometer comprises rotating or tilting the pet feeding activity detector outside of its normal operation range and then back. The microcontroller is programmed such that exiting a normal operating orientation causes cessation of indication. With the pet feeding activity detector affixed to a bowl, the reset action is accomplished by tilting the bowl to momentarily place the face of the housing parallel to the ground.

In a second embodiment, the pet feeding activity detector is integrated into a pet bowl. A PCBA with electronics is built into the wall or floor of the pet bowl. The bowl is designed to receive the PCBA and allow for substantially sealing the PCBA in a closed compartment. Indication means is an LED in the wall of the bowl that has wires to the PCBA or comprises a light pipe to guide light from an LED on the PCBA to the wall of the bowl.

In either the affixable or bowl-integrated pet feeding activity detector, further embodiments use alternate technologies for the sensing means. Although it does not offer the accelerometer-enabled features of ship mode, shelf mode, and reset action, capacitive sensing is attractive for its low cost, simplicity, and sensitivity. A capacitive sensing plate is fabricated as part the PCBA in either the affixable-housing or bowl-integrated embodiments. Or in the bowl-integrated embodiment, a separate capacitive sensing plate may be formed under the bottom surface of the pet bowl and electrically attached to the PCBA.

The circuitry required for capacitive sensing is well known in the art and typically comprises an oscillator circuit with a frequency that depends on the capacitance between the capacitive sensing plate and its environment. The oscillation frequency is measured by the microcontroller. Capacitance changes caused by the presence of food and moist animal muzzles and tongues are highly discernable.

Further embodiments use alternate sensing means of weight or force sensing; light sensing, either passive as with detecting the blockage of ambient light, or active as with an emitter-detector pair; and acoustic sensing, either passive as with a microphone, or active as with an ultrasonic emitter.

Further embodiments use the sensing means to detect user interface touch gestures, such as taps, multiple taps, tap and hold, or prolonged touches. These touch gestures may be uniquely assigned to the actions of reset (to cease indication) or increasing or decreasing the overall duration of indication. Multiple taps may cause the indication duration to be set to the number of taps; for example, tapping four times may cause the indication time to be set to four hours. To indicate a successful setting of the indication time, the LED may blink in response. The LED may blink a number of times equivalent to the duration of indication time, measured in hours.

Further embodiments add additional functionality to the indication means. In addition to the immediate and binary LED indicator, the indication means could include a radio such as Wi-Fi, Bluetooth, or other radio that transmits information about pet feeding activity to a receiver. The receiver could be a server reached over Wi-Fi and a home internet connection, or a phone app or server reached over Bluetooth to a mobile phone. Notifications or reminders about pet feeding activity could be sent to interested parties.

### BRIEF DESCRIPTION OF DRAWINGS

FIG. 1 is an image of a prior art product.

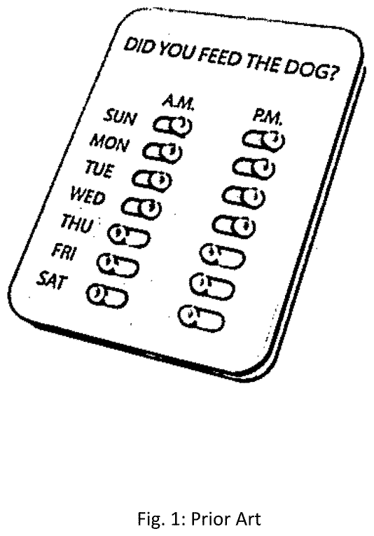

FIG. 2 shows frontal and perspective views of a device housing.

FIG. 3 shows a retail blister pack with the pet feeding activity detector rotated to an off position.

FIG. 4 shows a pet bowl with an incorporated pet feeding activity detector

FIG. 5 shows a coarse electrical schematic.

FIG. 6 depicts a software state machine.

FIG. 7 depicts a flowchart within the Idle state of the software state machine.

FIG. 8 depicts a flowchart within the Indication state of the software state machine.

FIG. 9 depicts a flowchart within the Ship/Shelf state of the software state machine.

FIG. 10 depicts a software state machine for a generic sensing means.

FIG. 11 depicts a software state machine for a sensing means having full vs. empty transition detection capability.

FIG. 12 depicts a sequence of states in the detection of pet feeding activity.

### DETAILED DESCRIPTION OF THE INVENTION

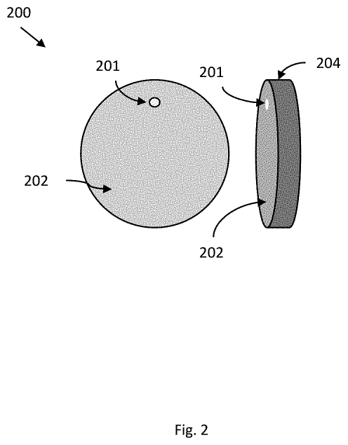

Embodiments of the invention are discussed below with reference to FIGS. 2-12. However, those skilled in the art will readily appreciate that the detailed description given herein with respect to these figures is for explanatory purposes as the invention extends beyond these limited embodiments.

Provided herein is an automatic system for detection and indication of pet feeding activity that is from the pet owner's perspective both effortless and extremely simple. A pet feeding activity detector comprises a sensing means, decision means, and indication means.

The animal feeding activity detector in a preferred embodiment is built within a housing that affixes to a pet bowl, and in a second embodiment is built within the bowl itself. The housing 200 of FIG. 2 is an example of a housing affixable to a bowl. The housing 200 may be relatively flat and disk-like, with a front face 202 and a parallel back face, and an outer perimeter 204 that could be round, square, or any shape. The housing may have some curvature so that its disk shape is not flat, but rather conforms slightly around the curvature of a pet feeding bowl. The housing may have some other features, such as an indication of the up direction and decorative features.

In a preferred embodiment, the housing may be formed by injection molding of two halves, which are then glued, ultrasonically welded, or otherwise joined, possibly in a water-tight manner. The battery may be permanently mounted within the housing, or the housing may have a battery door for a replaceable battery, of one of the many styles or designs known in the art of plastic cases for small electronic devices. Disposed within the housing are a battery and printed circuit board assembly (PCBA).

In an alternate construction, the housing is formed by encapsulation molding around a PCBA and battery, so that the pet feeding detector is encapsulated and waterproof. Such encapsulation molding may be performed at temperatures and pressures compatible with PCBAs and batteries. Encapsulation molding is highly waterproof, so the pet feeding activity detector would be dishwasher safe. Being permanently molded within the housing, the battery is not replaceable. However, power consumption of the circuitry can be made low enough that battery life may be many years.

The housing has a transparent or translucent window 201, for allowing the visibility of an indication LED on the PCBA. The translucent window may comprise a light pipe. The light pipe may be formed via injection molding as a separate piece. If the housing is comprised of injection molded plastic, the housing may have an opening in which the light pipe piece is viewable. If the housing is formed via encapsulation molding, the light pipe may be positioned in the encapsulation mold so that its viewable outermost face is flush with the surface of the resulting encapsulation and is not occluded by the encapsulation. The light pipe may be glued to the PCBA so that it does not fall off during handling and molding or encapsulation, or the light pipe may be formed with features that snap into slots or holes on the PCBA; such plastic snap and slot features are well known in the art. In some embodiments, the housing may also have a transparent window for allowing light to reach a small solar cell.

The housing has attachment means for semi-permanently affixing to a pet bowl. In a preferred embodiment the attachment means comprises VHB adhesive from 3M corporation. Additionally, or alternately, the attachment means could include magnets (for attaching to magnetic metal bowls) or a hook and loop fastener. When attached, the face of the housing will be substantially perpendicular to the ground; this is by virtue of the design of most pet bowls having outer side walls no further than 30 degrees of angle from vertical, and most much less.

Automatic detection of long-term storage of the pet feeding activity detector in a warehouse or on a store shelf will be described below. The housing may have a preferred orientation rotatably around an axis perpendicular to face 202 of the housing, which may be indicated by an arrow or an asymmetry. An example of an asymmetry is the light pipe 201 being placed near a top edge. When oriented outside a specified angular tolerance of vertical, the sensing and decision means described below may conclude that the pet feeding activity detector is not in use and enter a low power mode to conserve battery power.

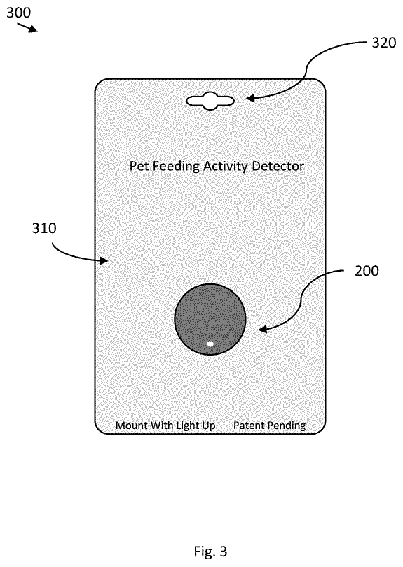

Deliberate storage of the pet feeding activity detector outside the specified angular tolerance of vertical is a signal to the sensing and decision means that a low power mode should be entered. Rotation is then effectively an on/off switch. This is useful in packaging, where for example the pet feeding activity detector might be sold in a blister pack that hangs from a hook in a store. FIG. 3 is an example blister pack 300 for retail display. Blister packs typically have a paper board substrate 310, with hole 320 for hanging on a shelf hook. The product, in this case the pet feeding activity detector 200, is captured against the paper board by a transparent plastic blister. Several methods of forming the plastic blister and attaching to the paperboard are known in the art. In FIG. 3 the pet feeding activity detector 200 is pictured rotated 180 degrees from vertical, which will be detected by the sensing and decision means and interpreted as a signal to enter a low power “ship/shelf” mode so that battery depletion can be avoided. The blister pack may have a feature to avoid undesired rotation of the pet feeding activity detector. In a preferred embodiment the feature is weak adhesive between the pet feeding activity detector and the blister pack substrate 310. Alternately, the feature could be the blister pack fits tightly against the pet feeding activity detector.

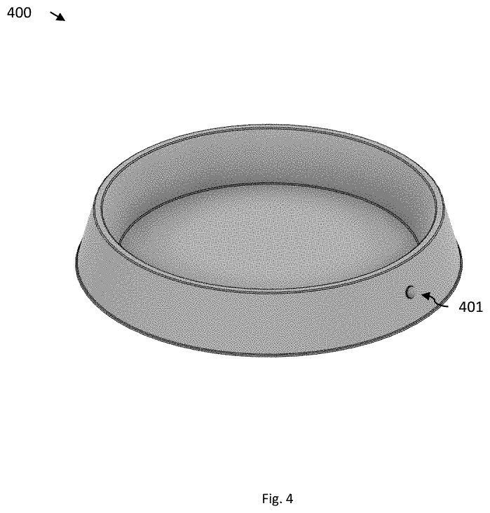

In an alternate embodiment, the housing of the pet feeding activity detector comprises a pet bowl, such that that pet feeding activity detector is built into the bowl. FIG. 4. shows an example bowl 400, with indication means 401 on a side surface of the bowl. The indication means could be an LED mounted in the wall of the bowl, with wires to the PCBA; or, as with the detached self-contained housing embodiment, the indication means 401 could be a light pipe like light pipe 201. The light pipe carries light from an LED on a circuit board to a viewable location. The visible aspect of light pipe 401 could be flat, spherical, or any other designed shape. The circuit board built into bowl 400 could be inside the wall, near the indication means 401, or could be flat under the bottom surface of bowl 401. If the sensing means discussed below is capacitive proximity sensing, orienting the circuit board under the bottom surface of the bowl may be advantageous for forming a capacitive sensing plate.

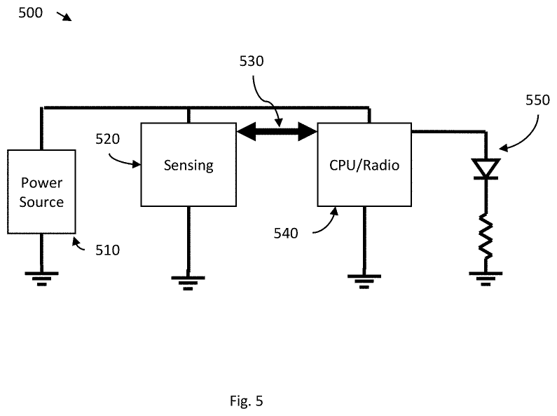

FIG. 5 is a coarse electrical schematic 500 of the pet feeding activity detector. The circuit includes a power source 510, a sensing means 520, a communication means 530, a CPU 540, and an indication means 550. The circuit components, as is typical of electronic devices, are built onto a printed circuit board (PCB) to comprise a printed circuit board assembly (PCBA). The PCBA is contained within the housing.

In a preferred embodiment, the power source 510 is a battery, such as a non-rechargeable CR2032 lithium coin cell. Alternately the power source 510 could be a small photovoltaic cell, with an appropriate storage device and circuitry to provide voltages necessary for the rest of the circuit. For this purpose, circuitry could include energy harvesting integrated circuits, such as part numbers SPV1040 or SPV1050 from ST Microelectronics. Storage devices could include a rechargeable battery, a capacitor, or a supercapacitor.

The pet feeding detector activity detector contains a sensing means 520. The sensing means detects signals related to feeding activity, such an animal eating from a bowl but also for example humans lifting, touching, or filling a pet bowl; humans interacting with electronic controls of the pet feeding activity detector; and even the orientation, shipping, or storage of the pet feeding activity detector. All such interactions and happenings with a pet bowl are herein broadly referred to as “feeding activity.”

In a preferred embodiment, the sensing means 520 is an accelerometer such as for example part number LIS2DW12 from ST Microelectronics. A pet owner filling a food dish, or a pet nudging a bowl while eating, causes vibrations and motions that induce (by virtue of mechanical attachment) corresponding accelerations of the pet feeding activity detector. These accelerations are sensed by the accelerometer. Although such motions may be tiny and imperceptible to a human, they may be easily sensed by an accelerometer capable of reliably detecting tens of milli-g's change from a resting value. Herein the terms “motion” and “acceleration” are used interchangeably. Detection of motion comprises measuring readings from the accelerometer and detecting change from a resting value.

The accelerometer may be a three-axis accelerometer, which in the absence of dynamic acceleration reports orientation relative to gravity. This orientation information enables the ship/shelf mode described above.

Alternately or in addition, the sensing means may include capacitive proximity sensing. A capacitive sensing plate is formed as a conductive area on the printed circuit board, or as a conductive element (such as foil) arrayed within housing or bowl and coupled to the circuit by soldering or a soldered wire. As is well known in the art of capacitive proximity sensing, the plate is driven by a circuit to couple charge into its nearby environment. The presence of an animal near the sensing plate changes the local capacitance, and therefore the amount of this charge.

Several alternate circuits could be used to sense the changes in capacitance caused by the presence of a pet. A common method is with an oscillator circuit, where an oscillator may be formed with a 555 timer, or a relaxation oscillator may be formed with an op-amp or a logic gate. The capacitance of the sensor plate to its environment determines the oscillation frequency. Typically, the oscillator output is a square wave that is input to a microcontroller such as 540, where an internal counter determines the number of oscillations within a fixed time in order to determine the oscillation frequency.

Yet other sensing means are possible. Optical sensing, in which an animal either blocks ambient light or reflects emitted light, is possible. Such circuits are common and known in the art of automatic faucets or paper towel dispensers.

Passive optical detection comprises using a photodiode to detect ambient light. The photodiode is aimed toward the center of the dog bowl, so that food and animal presence reduce the amount of ambient light reaching the photodiode. The photodiode is coupled to an amplifier circuit, many varieties of which are well known in the art, which provides a signal that is measured by an analog to digital converter (ADC) such as those typically found integrated into CPU 540, which measurements are then used by the decision means. Observing decreased ambient light for a minimum duration (for example one minute) is sufficient to conclude that feeding activity has occurred.

Active optical detection, in which light is emitted into a space, reflected by objects in the space, and received by a sensor, are typically used for distance measurements. These devices operate with several sensing principles, such as for example brightness of reflection or time-of-flight of emitted and reflected pulse. Devices such as part number VL53LCCXV0DH/1, from ST Microelectronics, Inc. which uses the time-of-flight measurement technique, are easy to integrate and use. Similarly to an accelerometer chip, these chips communicate range readings to CPU 540 over a communications bus 530. The sensor is aimed toward the center of the bowl, so that the sensor determines the distance to any object within and slightly over the bowl. The presence of an animal head in the bowl causes the measured range to decrease. Observing a decreased range for a minimum duration (for example one minute) is sufficient to conclude that pet feeding activity has occurred.

Acoustic sensing is also useful and sufficient for detecting feeding activity. This could be passive, with a microphone element or piezoelectric acoustic vibration sensor detecting the acoustic vibrations caused by animal biting and mastication of food. Or, the acoustic detection could be active, such as with ultrasonic presence detection. Care would be required to use ultrasonic frequencies higher than those annoying to animals.

Passive acoustic sensing comprises using a microphone or an acoustic vibration sensor, such as polyvinylidene fluoride (PVDF) film, for example from Measurement Specialties, Inc. An amplifier circuit, many varieties of which are well known in the art, provides a signal that is measured by an analog to digital converter (ADC) such as those typically found integrated into CPU 540, which measurements are then used by the decision means. Acoustic signals corresponding to feeding activity, detected for a minimum duration (for example one minute), are sufficient to conclude that feeding activity has occurred.

Active acoustic sensing, in which an ultrasonic pulse is emitted, reflected from nearby objects, and detected, are typically used for distance measurements. Monolithic solutions for such ultrasonic range finding, such as the CH101 from TDK Corporation, are available and simple to integrate. Similarly to an accelerometer chip, these chips communicate range readings to CPU 540 over a communications bus 530. Ultrasonic pulses are aimed to within the center of the dog bowl, so that the sensor is determining the distance to any object in the space within and slightly over the bowl. The presence of an animal head in the bowl causes the measured range to decrease. Observing a decreased range for a minimum duration (for example one minute) is sufficient to conclude that pet feeding activity has occurred.

Yet another sensing means could be force or weight measurement. Sensors such as strain gauges and their associated electronics are well known in the art of scales. If a weighing means is interposed between a food bowl and the support of the food bowl, then the weighing means can determine when a bowl is filled by a human and emptied by an animal. Such systems are typically designed to ignore fluctuations, in favor of displaying a static weight. However, if configured to capture the forces of an animal nudging and nuzzling in the bowl, a force sensor could directly detect feeding activity in addition to the transitions between empty, full, and empty again.

Different sensing modalities have different pros and cons. Measuring acceleration enables the low power ship/shelf mode by detecting orientation or the vibrations characteristic of shipping. Accelerometers are low power, easy to design with, and relatively inexpensive. A capacitive sensor, on the other hand, might be even more cost effective and low power. In addition to sensing the presence of the feeding animal, capacitive sensing can also differentiate a filled from empty bowl. Weight sensing has the advantage of determining the quantity of food consumed, but at the cost of higher mechanical complexity. Weight sensing may also have poor reliability, since strain gauges are prone to drift with temperature changes and rough handling and can even be rendered inoperable by mechanical abuse. Because weight sensing requires two parts with relative mechanical motion, it may be more difficult to design a sealed and washable system compared other types of sensing means.

In a preferred embodiment the decision means of the pet feeding activity detector comprises a microcontroller 540 containing instructions for processing data from the sensing means to ascertain the presence of pet feeding activity. Example flowcharts for this process will be given below. The microcontroller 540 may also comprise a Bluetooth, Wi-Fi, or other radio, either integrally or in a companion chip, as part of an indication means.

The sensing means 520 is coupled to the microcontroller 540 through a communication means 530. If the sensing means is an accelerometer, the communication means could be a SPI, 12C, or other communication bus over which data is requested or sent. The communication means may also comprise an interrupt line. If the sensing means includes a capacitive sensing oscillator, the communication means may include the above-mentioned square wave input to a counter pin on microcontroller 540. Any capacitance sensing circuitry may be contained within the microcontroller 540, a common capability embedded in microcontrollers.

In some embodiments, sensing means 520 could be a device such as an accelerometer that also contains a decision means, that is the capability to detect motion activity above a threshold amount. The LIS2DW12 from ST Microelectronics, for example, can be set to indicate activity above a threshold amount by raising an interrupt output high. This pin could then be used to drive an indication means, such as a circuit to drive or flash an LED, without the necessity of a microcontroller 540.

The pet feeding activity detector contains an indication means to indicate the existence of recent pet feeding activity. In a preferred embodiment, the indication means is an LED 550. The LED could be driven simply by an output of the microcontroller 540. Many other LED driving schemes are commonly known, such as for example transistor circuits to deliver constant current, or inductor or capacitor circuits to slowly store energy and release it in bursts. A charge pump or inductive boost converter could create voltage for driving an LED that requires a voltage higher than the voltage available directly from power source 510. The light from the LED is made visible through light pipe 201 or 401, visible on the outside of housing 200 or bowl 400.

Because the indication means is integral with the pet feeding activity detector, it is immediate to human users in both the spatial and temporal sense. That is, the indication is available where and when needed by the human, with no steps required other than a glance. Also, the indication means is binary, in the sense that it is either flashing or not. No interpretation is required in order to understand if the pet has been fed.

The indication means may additionally comprise a radio, such as a Bluetooth or Wi-Fi radio. The radio may transmit notifications to a web server or to personal devices of humans caring for an animal, to indicate that the animal has been fed. The absence of pet feeding activity indications during a time window of expected activity may prompt a reminder notification. The reminder notification could be sent directly from the feeding activity detector to a mobile phone, or from a server to a person. The radio may be packaged with the CPU as one integrated circuit 540, such as for example part number nRF52805 from Nordic Semiconductor, Inc.

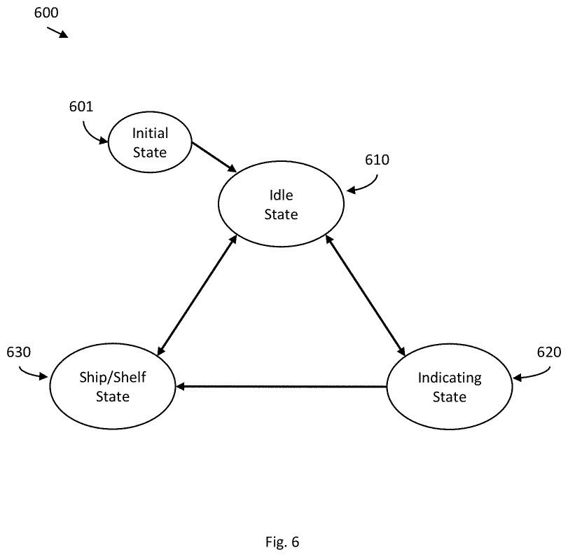

In a preferred embodiment, the decision means consists of computer instructions running in microcontroller 540. Many possible algorithms for these computer instructions are possible. As one example of an algorithm and a preferred embodiment, FIG. 6 is a software state machine 600 for operating the pet feeding activity detector with sensing means comprising an accelerometer. The state machine has an initial state 601, an idle state 610, an indicating state 620, and a ship/shelf state 630. The state machine may be executed periodically on a schedule, such as for example once per second, such that except during moments of state machine execution the system may spend a large amount of time in low power sleep modes. The timing of the schedule may be driven by a timer in the microcontroller 540, or in the accelerometer 520.

The sole purpose of initial state 601 is to perform initialization upon first power-up and to enter idle state 610.

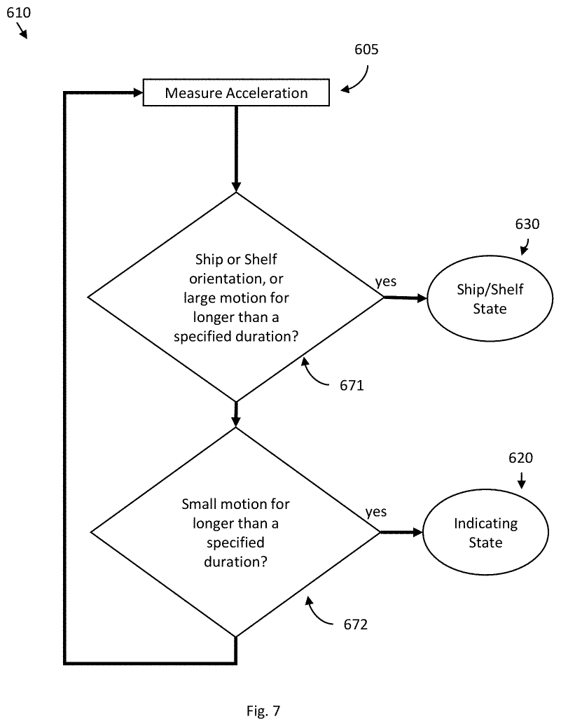

The purpose of idle state 610 is to decide whether the pet feeding activity detector should begin indicating activity in indicating state 620 or should enter power saving mode in ship/shelf state 630. The actions within idle state 610 are described in FIG. 7. As in each of the three main states 610, 620, and 630, the first step 605 is to acquire a measurement from the accelerometer. Data acquisition may happen actively, such as for example the microcontroller waking up every second to query the accelerometer; or it may happen more passively, such as for example the accelerometer periodically asserting an interrupt line to wake the microcontroller so measurement data may be transferred.

A second step 671 within idle state 610 checks first for unexpected device orientation or large extended motion. Unexpected device orientation indicates that the pet feeding activity detector is not in use. If the accelerometer data indicates that the housing 200 is not substantially perpendicular to the ground, or that bowl 400 is not substantially parallel to the ground, then the system is not in a usable orientation for containing food and feeding an animal (for example it may be in a dishwasher, stored on a shelf, etc.). In this case step 671 will switch the state machine state to 630, the ship/shelf state.

Also in step 671, state 630 is entered if large accelerations are detected for a duration longer than a specified duration. The accelerations caused by filling a pet bowl and then eating from the bowl are small, typically on the order of tens of milli-gs. Larger accelerations, such as over 0.2 g, indicate that the pet feeding activity sensor is in motion, and therefore not in use by a pet. Of course, a pet owner may lift a pet bowl and with the pet feeding activity detector to a countertop for filling, and such an action would be detected as a relatively large motion. However, if large motions continue beyond a few minutes, it is much more likely that the pet feeding activity detector is bouncing along in a shipping container at sea, on its way from a manufacturing plant to a warehouse. If large accelerations continue beyond a specified duration, step 671 will switch the state machine state to 630, the ship/shelf state. A minimum duration of activity required for entering ship/shelf mode should be longer than the longest expected duration of pet feeding activity. Five minutes is a practical minimum.

Step 672 of idle state 610 checks for motions expected from pet feeding activity. If motions persist over a specified minimum amount of time, then the indicating state 620 is entered. The minimum duration of motion duration for entering the indicating state should be long enough that short spurious signals, such as motion of nearby footfalls, are ignored; and it should be short enough that feeding activity from a wide range of pets, from small kittens to large dogs, can be reliably detected. In practice one minute is a useful duration threshold.

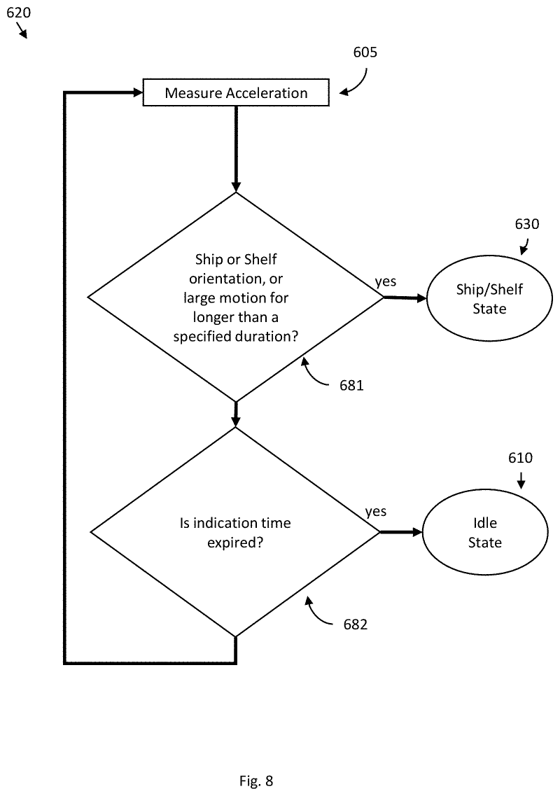

The purpose of indicating state 620, pictured in FIG. 8, is to manage the indication that pet feeding activity was found. A first step 605, as in other states of state machine 600, is to acquire accelerometer data. In the indication state 620, step 605 is optional and could be omitted to save power. However, having the accelerometer data enables step 681 to be performed in case ship/shelf state 630 needs to be entered from within indicating state 620. While within the indicating state, the indication means is exercised. If the indication means is an LED, it is turned on or periodically flashed. If the indication means also contains a Bluetooth radio or other RF transmission means, information is transmitted that pet feeding activity has been found. An RF transmission may happen only once or a few times per entry into the indicating state, to conserve power.

Step 681 of the indicating state 620 checks for whether ship/shelf mode should be entered. This is identical to step 671. We could optionally drop the requirement that extended motions be large, since activity detected over a prolonged period need not be large to disqualify determination as pet feeding activity. For example, motions in a car or ship might sometimes be gentle but are still distinguishable by their extent. A practical minimum duration to disqualify pet feeding activity is greater than five minutes.

In step 682, the time spent within the indicating state is checked against a specified indication duration. An optimal indicating duration is long enough that all persons concerned may view the indication means to learn that a pet has been fed, but not so long that indication from one feeding could overlap a feeding later in the same day. The specified duration could range from one-half to six hours, with four hours seeming optimal. If the indication duration has reached the specified duration, the state returns to idle state 610.

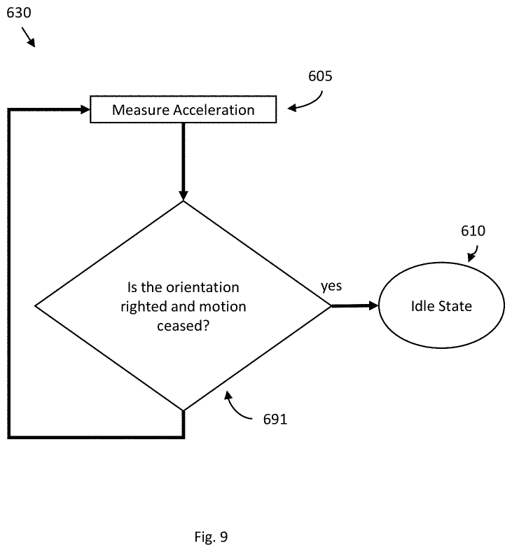

The ship/shelf state 630 is pictured in FIG. 9. Within state 630, a first step 605 is to acquire acceleration data. In a second step 691, the orientation of the pet feeding activity detector relative to the ground, and the status of large motions are checked. If usably oriented, and if no large motions have been present for a specified amount of time, the state is returned to idle state 610. A useful minimum duration for the cessation of motion is on the order of minutes, so that ship/shelf state is maintained during true shipping but exited quickly once the pet feeding activity detector is put into true service. A practical minimum is 30 seconds.

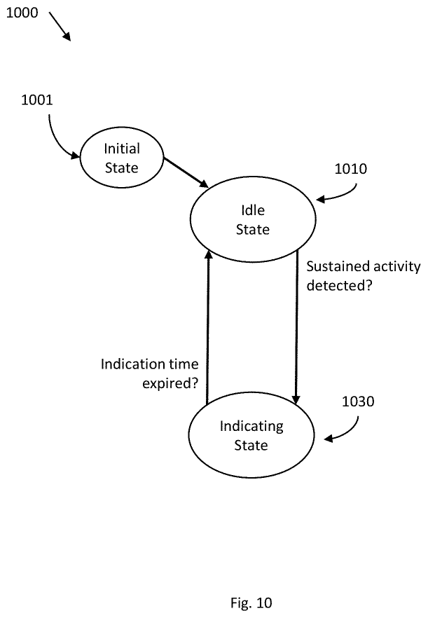

In the state machine described above, the sensing means comprised an accelerometer alone. In other embodiments the sensing means may alternately or additionally include capacitive proximity sensing, optical proximity detection, acoustic detection, weight measurement, or other means. With a sensing means that is not an accelerometer, the state machine 600 is simplified with the removal of the ship/shelf state uniquely enabled by the accelerometer. A simplified state machine with generic sensing means is pictured in FIG. 10.

State machine 1000 has an initial state 1001 whose sole purpose is to perform initialization upon first power-up and to enter idle state 1010. Idle state 1010 checks for activity using the sensing means. If activity is sustained beyond a minimum duration, for example one minute, then indicating state 1030 is entered. While in state 1030, the indication means (LED, radio, notifications) is utilized to indicate feeding has occurred. State 1030 is exited for the idle state 1010 once the predetermined indication duration (for example four hours) is reached.

Some sensing means, such as capacitive or weight sensing, may have the capability to distinguish full vs. empty states of a pet bowl in addition to or instead of directly sensing feeding activity. Such sensing means may be insufficiently accurate to absolutely determine emptiness or fullness from a single measurement but can detect the changes caused by filling and emptying sufficiently to determine the state of emptiness or fullness. For example, a weighing mechanism may be insufficiently accurate to decide from a single measurement if a bowl contains food; but a series of measurements may show a sudden transition upward in weight when filled with food, and the mechanical jostling and slow downward change in weight when an animal eats the food.

Without food or activity, the sensing means has a background measurement value, such as the system's parasitic capacitance or the currently measured weight of the bowl (tare weight). When the measurement changes suddenly by more than a threshold value, and then stabilizes at a filled measurement value, the bowl is presumed to have been filled. In the case of capacitance measurement, fluctuations from the filled measurement value are caused by the presence and feeding action of the animal and gradual emptying of the bowl. In the case of weight measurement, fluctuations from the filled measurement value are caused by mechanical nudging from the animal and gradual emptying of the bowl. Feeding completion is indicated by the cessation of fluctuations caused by feeding actions, and the stabilization of the measurement value at an emptied measurement value. The emptied measurement value may be largely a return to the background measurement value but may be different due to hysteresis or residual food or moisture.

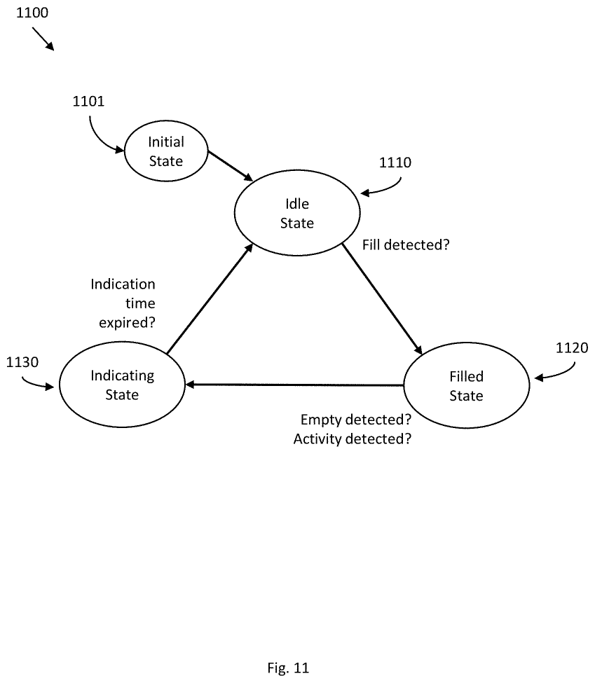

A state machine for a system with sensing means capable of distinguishing transitions between empty and full is shown in FIG. 11. State machine 1100 has an initial state 1101 whose sole purpose is to perform initialization upon first power-up and to enter idle state 1110. Idle state 1110 checks for activity using the sensing means and establishes a background measurement level such as steady-state capacitance or tare weight. If while in the idle state 1110 the measurement level changes by more than a threshold, the bowl is presumed to be filled and the state machine enters state 1120. If while in the in the filled state 1120 the measurement level changes toward the background measurement level by more than a threshold, and or activity detection ceases for more than a specified amount of time, the bowl is presumed to be empty, or the pet is presumed to have been fed and the state machine transitions to indicating state 1130. While in indicating state 1130, the indication means (LED, radio, notifications) is utilized to indicate feeding has occurred. State 1130 is exited for the idle state 1110 once the predetermined indication duration (for example four hours) is reached.

The software state machines described above are only examples of the many ways that the aims of this invention can be accomplished. States could be subdivided further, alternately named, added, or eliminated. The software could be devised without the paradigm of a state machine.

The steps of an algorithm for concluding that pet feeding activity has occurred vary depending on the capabilities of the sensing means. An accelerometer detects only vibrations and gives no indication of whether a bowl has been filled. A capacitive sensor, in contrast, can be sensitive enough to detect that a bowl has been filled with food, that an animal is present, and that the food level in a bowl is decreasing. Likewise, a force sensor can detect that mass has been added to a bowl and that an animal is nudging the bowl while mass is decreasing.

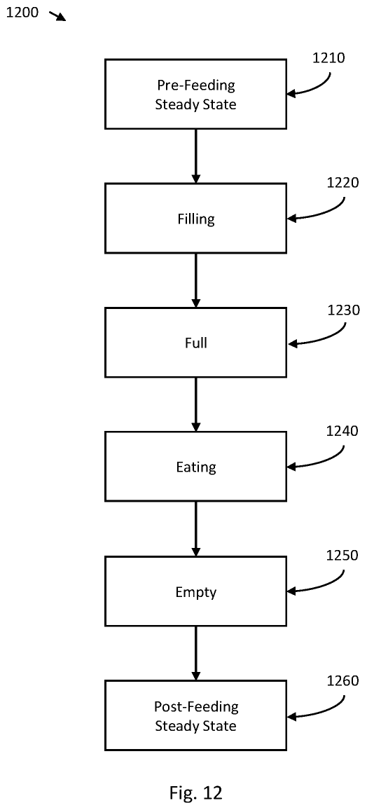

A generalized sequence of stages that occur during pet feeding activity is shown in FIG. 12. Stage 1210, the steady state stage, is the stage of prolonged non-activity. In this stage, the pet bowl is not in use. Stage 1220, the filling, comprises a human adding food to the pet bowl. The bowl is then full in stage 1230. The bowl may stay full for some time, or a pet might begin eating immediately. In stage 1240, an animal is eating and the bowl is becoming empty. In stage 1250, the bowl is empty. In stage 1260, the post-feeding steady state, the pet bowl is once again not in use. After a prolonged period of non-use, stage 1260 becomes stage 1210 and the sequence repeats. Both stages 1210 and 1260 are analogous to the idle states 610, 1010, and 1110 of state machines 600, 1000, and 1100 respectively.

The stages in FIG. 12 and transitions between the stages are observable in different ways with different sensing means. With the preferred embodiment of accelerometer sensing means, the pre-feeding steady state stage is a prolonged period during which no significant motion is detected. The filling of the bowl, stage 1220, may be detected as motion especially if the bowl is moved for filling. However, the mechanical disturbances caused by filling are not necessarily unique and distinguishable from for example an accidental foot nudge. An accelerometer is not capable of providing positive evidence of fullness (state 1230). In contrast, an accelerometer provides ample and unique evidence of stage 1240, as the animal nudges the bowl and food during eating. It is the motion for a minimum specified duration, in decision block 672 of idle state flowchart 610, that leads the decision means to conclude that animal feeding is occurring. Also, with an accelerometer sensing means, the state of emptiness is not positively detectable but can only be inferred from a cessation of feeding motion in stage 1240. Fortunately, it is not necessary to positively identify filling, fullness, or emptiness; the motion from feeding activity in contrast to steady-state idleness is unique and sufficient.

With the alternate embodiment of capacitive sensing means, the pre- or post-feeding steady states are detectable by observing a relatively stable and unchanging value of capacitance. Filling, state 1220, is presumed if the capacitance increases sharply to a new relatively stable value, after which state 1230 is presumed. The signals from eating in stage 1240 include a rise in capacitance with the proximity of an animal head and mouth, and fluctuations in capacitance as the animal moves around their head and the food. Capacitance will fall as the food is consumed and will fall again with the absence of the animal. The empty state is presumed if fluctuations cause by animal activity cease, and the capacitance falls significantly back toward the value it had in in the pre-feeding steady state. Prolonged stability of the capacitance value indicates the post-feeding steady state stage is reached.

The use of a capacitive sensing means allows a more positive identification of the filling, full, and empty states than does the preferred accelerometer means. The filling of the bowl shifts the capacitance to a new higher level, and the emptying returns it to near the pre-filled level (with differences due to residual moisture and food). A state machine decision step, like step 672 in flowchart of the idle state of state machine 610, could add additional tests for whether the stages 1220 through 1250 of filling, full, eating, and empty are progressed through in sequence. In practice, it is sufficient to require detection of fluctuations caused by filling and eating collectively, for a minimum duration (for example one minute), to conclude that feeding activity has occurred.

With the alternate embodiment of weight or force sensing, measurements give unambiguous indication of being filled (stage 1220), being full (stage 1230), and of being empty again (stage 1250) because the sensing means output is directly proportional to the mass of food present in the bowl. If configured to do less averaging than is typical of weight sensors, fluctuations caused by forces of an animal interacting with the food may be detectable during eating stage 1240. Sufficient evidence for concluding that feeding activity has occurred comprises detecting a transition from idle stage 1210 to full stage 1230, and then empty stage 1250. If so configured to observe fluctuations from force, detecting those fluctuations for a minimum duration (for example one minute), is alone sufficient.

Further alternate embodiments of the sensing means include acoustic and optical, both of which could be passive or active. Acoustic signals corresponding to feeding activity, either the sounds of activity or range reduction, detected for a minimum duration (for example one minute), are sufficient to conclude that feeding activity has occurred. Optical signals corresponding to feeding activity, either reduced ambient light or range reduction, detected for a minimum duration (for example one minute), are sufficient to conclude that pet feeding activity has occurred.

In the preferred and all the alternate sensing means embodiments, where delineated as capable in the above, detecting at least one transition between states in the sequence including steady-state inactivity, filling, full, eating, and empty is sufficient to determine that pet feeding activity has occurred. For example, capacitive and weight or force sensing might easily detect the filling of the bowl. Or, weight and force sensing might easily detect gradual the emptying of the bowl. Any such transition by itself is sufficient to determine that pet feeding activity has occurred.

The pet feeding activity detector reset feature mentioned previously as part of the preferred accelerometer sensing embodiment detects an intentional tilt and then ceases indication. With the accelerometer and various of the other sensing means, the reset action could comprise additional or alternate detectable user actions besides tilting. Actions detectable by the various technologies include a single tap, double tap, higher multiple taps, tap and hold, long touch, or combinations of those gestures. The accelerometer sensing means can detect taps as isolated impulses of small motion. The capacitive sensing means can detect taps and longer touches as periods of increased capacitance. Passive acoustic sensing means can detect taps as momentary acoustic vibrations. Passive optical sensing means can detect taps and touches as momentary reductions in brightness of detected ambient light. Distance sensing methods such as active acoustic sensing and active light sensing can detect taps and touches as moments of extreme minimal proximity. Weight or force sensing can detect taps and touches as moments of force impulse or increased measured weight. The art of detecting and distinguishing between tap and touch gestures is well known in the art touchpad human computer interfaces.

One of the touch gestures, for example a prolonged touch, may be uniquely assigned to the reset function. For example, in an embodiment with sensing means capable of detecting prolonged touch such as capacitive sensing, a prolonged touch will cause the cessation of indication.

In addition to the reset feature, the pet feeding activity detector may provide additional minimal user interface functions. In the case where an animal is fed multiple times per day, or for reasons of preference, it may be desirable to change to duration of the indication. For example, if an animal is fed at both 8 am and noon, a four-hour indication time would cause ambiguity; a human seeing flashing at noon would not know if the animal was just fed at noon. As another example, if an animal is fed between 8 am and 10 am, but sometimes not checked until noon, a four-hour indication time would again cause ambiguity; a human checking at noon would not know for sure if the animal was fed at 8 am, or not at all.

To enable changing the duration of indication, any of the detectable touch gestures may be assigned to raising and lowering the touch duration. For example, single and double taps may respectively lower and raise the indication duration by one hour. Alternately, the touch duration may be set equal to the number of consecutively detected taps, for example allowable between two and twelve taps. The successful change of indication duration may be indicated by flashing the indication means LED a number of times equal to the number of hours in the indication duration.

The term “pet” has been used in all the above, but the meaning and intent remain the same if the animal whose feeding is being monitored is any animal at all, including for example farm or zoo animals.

The term “food” has been used in all the above to indicate an item consumed by an animal; the meaning and intent remain the same if the consumable is a liquid such as water.

The term “bowl” has been used in all the above to indicate a vessel containing a consumable for an animal, but the meaning and intent remain the same if the vessel is any item meant to hold, contain, or present food to an animal such as a trough, basket, or platform.

It is claimed:

1. An animal feeding activity detector integral or affixed to a feeding bowl, comprising sensing means, decision means, and indication means, wherein:
the sensing means comprises at least one selected from the group of acceleration sensing, capacitive sensing, optical sensing, acoustic sensing, and force sensing, and functions to provide signals in response to feeding activity; and
the decision means comprises a microcontroller reading measurements from the sensing means, with programmed instructions to determine if feeding activity has occurred for longer than a minimum specified duration, and to control the indication means; and
the indication means comprises at least an immediate and binary indicator light.

2. The animal feeding activity detector of claim 1 wherein:
the sensing means comprises at least acceleration sensing, and detection of orientation different than normal operating orientation of more than a minimum tilt angle causes entry into a low power mode without indication, and wherein the minimum tilt angle is greater than 30 degrees.

3. The animal feed activity detector of claim 2, wherein:
packaging for shipping, warehouse storage, and retail display are designed to maintain orientation more than a minimum tilt different than normal operation orientation.

4. The animal feeding activity detector of claim 1 wherein:
the sensing means comprises at least acceleration sensing, and detection of motion for a duration longer than a first minimum duration causes entry into a low power mode without indication, and cessation of activity for a duration longer than a second minimum duration causes resumption of normal operation; and wherein the first minimum duration is at least 5 minutes, and the second minimum duration is at least 30 seconds.

5. The animal feeding activity detector of claim 1 wherein:
the indication means additionally comprises a radio.

6. The animal feeding activity detector of claim 1 wherein:
the sensing means can detect one or more of the touch gestures from the set of single tap, multiple taps, tap and hold, and prolonged touch; and each of the detectable touch gestures is uniquely assigned to one of the user interface actions from the set of ceasing indication, increasing indication duration, decreasing indication duration, and setting the indication duration equal to a number of taps.

7. An animal feeding activity detector integral or affixed to a feeding bowl, comprising sensing means, decision means, and indication means, wherein:
the sensing means comprises at least one selected from the group of acceleration sensing, capacitive sensing, optical sensing, acoustic sensing, and force sensing, and functions to provide signals in response to feeding activity; and
the decision means comprises a microcontroller reading measurements from the sensing means, with programmed instructions to detect at least one transition between an earlier and later stage in the sequence including steady-state inactivity, filling, full, eating, and empty in order to determine that feeding activity has occurred, and to control the indication means; and
the indication means comprises at least an immediate and binary indicator light.

8. The animal feeding activity detector of claim 7 wherein:
the sensing means can detect one or more of the touch gestures from the set of single tap, multiple taps, tap and hold, and prolonged touch; and each of the detectable touch gestures is uniquely assigned to one of the user interface results from the set of ceasing indication, increasing indication duration, decreasing indication duration, and setting indication duration equal to a number of taps.

9. The animal feeding activity detector of claim 7 wherein:
the indication means additionally comprises a radio.
